(19) United States
(12) Patent Application Publication
(10) Pub. No.: US 2004/0160776 A1
(43) Pub. Date: Aug. 19, 2004

(54) Illuminant module and method of manufacturing the same

(76) Inventors: Po-Hua Fang, Hsinchu (TW); Shu-Ya Chiang, Taichung (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/368,921

(22) Filed: Feb. 18, 2003

(51) Int. Cl. F21S 2/00

(52) U.S. Cl. 362/257

(57) ABSTRACT

A manufacturing method for illuminant module is provided. The illuminant module, which is used to be installed in an image retrieving device, includes an illuminant, a transparent protective layer and a reflecting plated layer. The transparent protective layer envelops at least a part of the tube of the illuminant and protects the structure of the illuminant from being damaged by collision or compression caused by external forces. The reflecting plated layer, which, being installed in the transparent protective layer but situated at one side of the tube of the illuminant, is used to reflect a part of the light generated by the illuminant and direct the light to be emitted outwardly in the same direction, so that illumination efficiency and illuminant accuracy can be enhanced.

This application claims the benefit of Taiwan application Serial No. 91108284, filed on Apr. 22, 2002.

### BACKGROUND OF THE INVENTION

1. Field of the Invention

The invention relates in general to an illuminant module and its manufacturing method, and more particularly to an illuminant module and its manufacturing method which protects the illuminant structure and directs the generated light to emit outwardly in the same direction.

2. Description of the Related Art

Image retrieving device has become indispensable to modern people who highly value living quality and are devoted to the pursuit of excellence. Take the scanner for an example, the user uses it to scan documents and retrieve needed images. Moreover, by coupling a scanner to a computer, the user can have the retrieved images stored and edited.

Modern people like products that are light, thin, short, small, and with high portability. Under such trend, the scanner is designed to be more delicate and sophisticated, and so is the physical size of its chassis getting smaller and smaller. Normally, an ordinary chassis is equipped with a lamp holder 132 as shown in FIG. 1. An illuminant, the cold cathode fluorescent lamp (CCFL) 134 for instance, is installed in the lamp holder 132 providing the needful scanned light during the chassis scanning.

The two ends of the CCFL 134 are fixed onto the lamp holder 132, so that the tube structure of the CCFL 134 is suspended over the lamp holder 132. Hence the CCFL 134 wabbles easily when external force applies. When it wabbles violently, the tube structure of the CCFL 134 is very likely to be broken or damaged. The same problem confronts other tube-type illuminants. Therefore, how to protect the structure of the cold cathode fluorescent lamp has become a technical problem which needs to be resolved urgently when the cold cathode fluorescent lamp is designed to be thinner and slenderer.

### SUMMARY OF THE INVENTION

It is therefore an object of the invention to provide an illuminant module and its manufacturing method. The design of having a transparent protective layer protects the structure of the illuminant lest it might be damaged by collision or compression caused by external forces. When incorporated with the design of a reflecting plated layer, the light generated by the illuminant can be further reflected and is directed to be emitted outwardly in the same direction. Thus the illumination efficiency and illuminant accuracy can be both improved. The illuminant module according to the invention can be buckled into the chassis directly saving the user assembly time.

It is another object of the invention to provide an illuminant module used to be installed in an image retrieving device, comprising an illuminant, a transparent protective layer and a reflecting plated layer. Of which, the transparent protective layer envelops at least a part of the tube of the illuminant and protects the structure of the illuminant; the reflecting plated layer, which, being installed in the transparent protective layer but situated at one side of the tube of the illuminant, is used to reflect a part of the light generated by the illuminant and direct the light to be emitted outwardly in the same direction.

It is another object of the invention to provide the manufacturing method for an illuminant module. First, an illuminant is provided. Next, a transparent protective layer is formed outside the illuminant; furthermore, the transparent protective layer envelops at lease a part of the tube of the illuminant, protecting the structure of the illuminant. Last, a reflecting plated layer is formed inside the transparent protective layer, wherein the reflecting plated layer, which, being installed in the transparent protective layer but situated at one side of the tubs of the illuminant, is used to reflect a part of light generated by the illuminant and direct the light to be emitted outwardly in the same direction.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 shows a three-dimensional schematic diagram for a lamp holder of a scanner;

FIG. 2 is a cross-sectional view for an illuminant module according to preferred embodiment one of the invention;

FIG. 3 is a cross-sectional view for an illuminant module according to preferred embodiment two of the invention;

FIG. 4 is a cross-sectional view for an illuminant module according to preferred embodiment three of the invention;

FIG. 5 is a cross-sectional view for an illuminant module according to preferred embodiment four of the invention; and

FIG. 6 is a flowchart showing the manufacturing method for an illuminant module according to the invention.

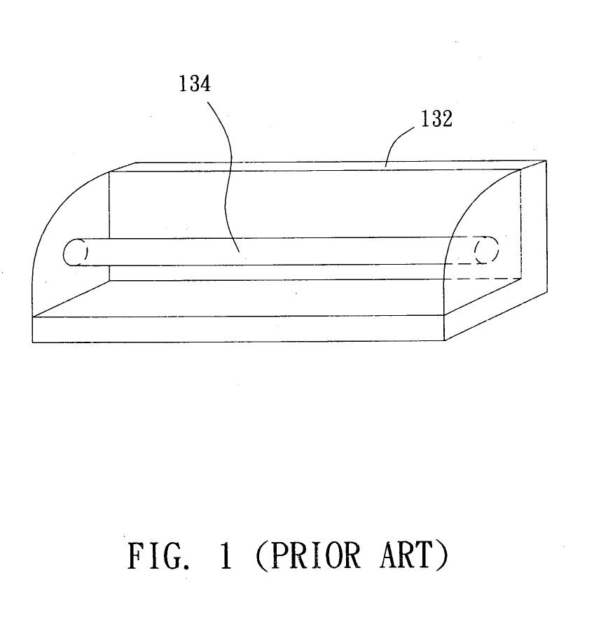

### DETAILED DESCRIPTION OF THE INVENTION

The invention particularly provides an illuminant module and its manufacturing method. The illuminant module is used to be installed in an image retrieving device, a scanner for instance, wherein the illuminant module includes an illuminant, a transparent protective layer and a reflecting plated layer. Of which, the transparent protective layer envelops at least a part of the tube of the illuminant to protect the structure of the illuminant and prevent the illuminant from being damaged by collision or compression caused by external forces; the reflecting plated layer, which being installed in the transparent protective layer but situated at one side of the tube of the illuminant, is used to reflect part of light generated by the illuminant and direct the light to be emitted outwardly in the same direction.

Practical applications of the illuminant module according to the invention are illustrated in preferred embodiment one to preferred embodiment four accompanied by charts and diagrams thereunder. The illuminant will be illustrated using a cold cathode fluorescent lamp (CCFL) as an example.

Embodiment One

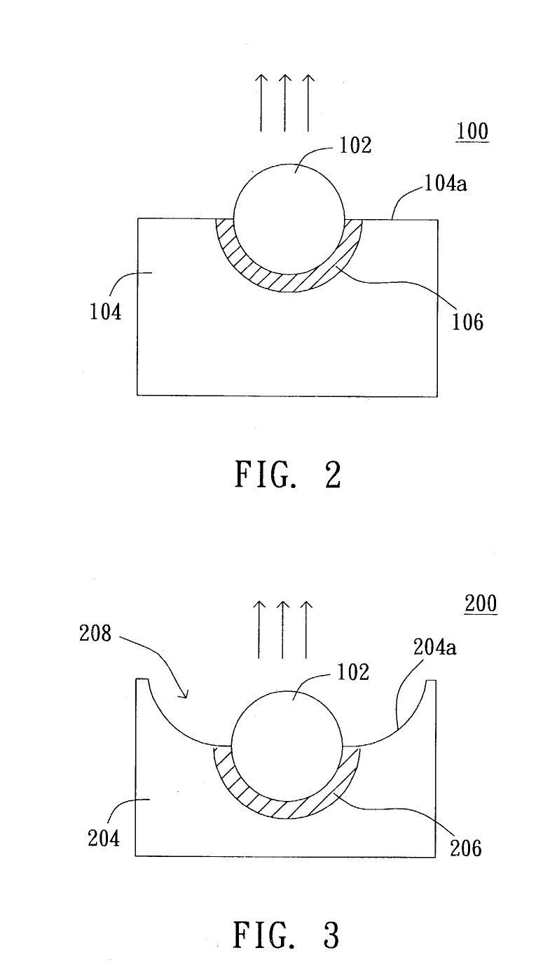

Please refer to FIG. 2, a cross-sectional view for an illuminant module according to preferred embodiment one of the invention. In FIG. 2, an illuminant module 100 is illustrated including a CCFL 102, a transparent protective layer 104 and a reflecting plated layer 106. The transparent protective layer 104 is formed outside the CCFL 102 via an ejection method so that the transparent protective layer 104 envelops the two ends and the part of the tube of the CCFL 102. As a result, a part of the structure of the CCFL 102 is exposed outside the upper surface 104a of the transparent protective layer 104.

It goes without saying that the transparent protective layer 104 of the invention is designed to protect the structure of the CCFL 102 from being damaged by collision or compression caused by external forces.

The transparent protective layer 106 is installed onto part of the tube of the CCFL 102 via an electroplating method and is used to reflect the light generated by CCFL 102. Besides, the reflecting plated layer 106 directs the light generated by the CCFL 102 to be emitted outwardly via the upper side of the illuminant module 100 so that illumination efficiency can be improved.

Embodiment Two

Please refer to FIG. 3, a cross-sectional view for an illuminant module according to preferred embodiment one of the invention. In FIG. 3, an illuminant module 200 is illustrated including a CCFL 102, a transparent protective layer 204 and a reflecting plated layer 206, wherein the transparent protective layer 204 has a groove 208. The transparent protective layer 204 is formed outside the CCFL 102 via an ejection method so that transparent protective layer 204 envelops the two ends and the part of the tube of the CCFL 102. As a result, a part of the structure of the CCFL 102 is exposed to be inside the groove 208 but outside the upper surface 204a of the transparent protective layer 204.

It goes without saying that the transparent protective layer 204 of the invention is designed to protect the structure of the CCFL 102 from being damaged by collision or compression caused by external forces.

The transparent protective layer 206 is installed onto the part of the tube of the CCFL 102 via an electroplating method and is used to reflect the light generated by the CCFL 102. It is noteworthy that the reflecting plated layer 206 and the groove 206 respectively are situated at the two lateral sides of the tube of the CCFL 102. Besides, the reflecting plated layer 206 directs the light generated by the CCFL 102 to be emitted outwardly via the upper side of the illuminant module 200 so that illumination efficiency can be improved.

Embodiment Three

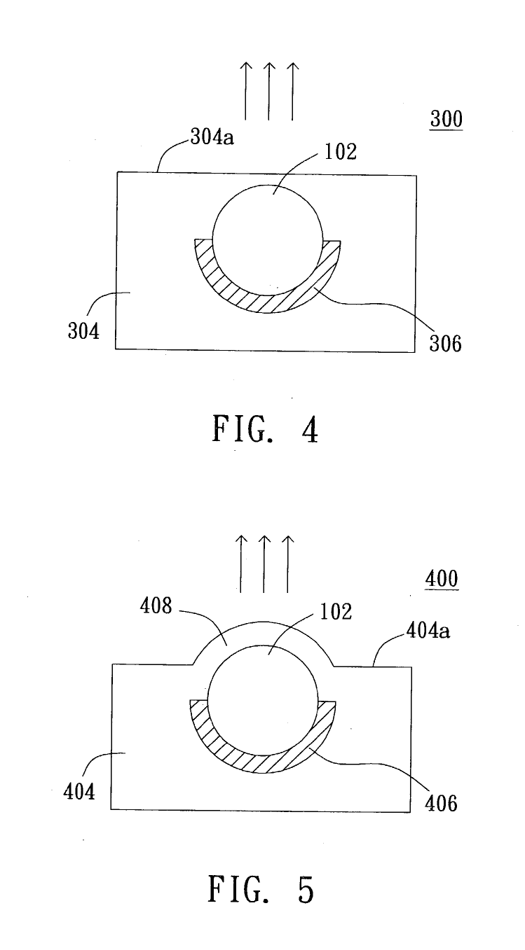

Please refer to FIG. 4, a cross-sectional view for an illuminant module according to preferred embodiment one of the invention. In FIG. 4, an illuminant module 300 is illustrated including a CCFL 102, a transparent protective layer 304 and a reflecting plated layer 306. The transparent protective layer 304 is formed outside CCFL 102 via an ejection method and is used to envelop the entire tube of the CCFL 102. In the preferred embodiment three, unlike the preferred embodiment one and the preferred embodiment two, not any part of the structure of the CCFL 102 is exposed to be outside the upper surface 304a of the transparent protective layer 304.

It goes without saying that the transparent protective layer 304 of the invention is designed to protect the structure of the CCFL 102 from being damaged by collision or compression caused by external forces.

The transparent protective layer 306 is installed onto part of the tube of the CCFL 102 via an electroplating method and is used to reflect the light generated by the CCFL 102. Besides, the reflecting plated layer 306 directs the light generated by the CCFL 102 to be emitted outwardly via the upper side of the illuminant module 300 so that illumination efficiency can be improved.

Embodiment Four

Please refer to FIG. 5, a cross-sectional view for an illuminant module according to preferred embodiment four of the invention. In FIG. 5, an illuminant module 400 is illustrated including a CCFL 102, a transparent protective layer 404 and a reflecting plated layer 406. The transparent protective layer 404 is formed outside the CCFL 102 via an ejection method and is used to envelop the entire tube of the CCFL 102.

It goes without saying that the transparent protective layer 404 of the invention is designed to protect the structure of the CCFL 102 from being damaged by collision or compression caused by external forces.

The transparent protective layer 406 is installed onto part of the tube of the CCFL 102 via an electroplating method and is used to reflect light generated by CCFL 102. Besides, the reflecting plated layer 406 directs the light generated by the CCFL 102 to be emitted outwardly via the upper side of the illuminant module 400 so that illumination efficiency can be improved.

The difference between the preferred embodiment four and the preferred embodiment three is that the former in particular has a light concentrating area 408 protruding to the upper surface 404a of the transparent protective layer 404. While the light concentrating area 408 and the reflecting plated layer 406 are respectively situated at the two lateral sides of the tube of the CCFL 102, the light concentrating area 408 is used to concentrates the light generated by the CCFL 102 and improve illumination efficiency accordingly.

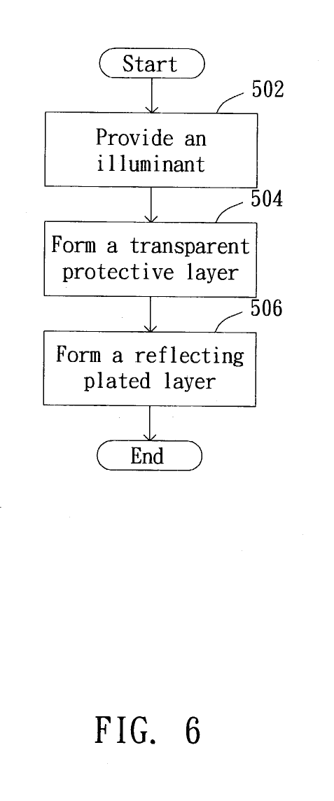

Please refer to FIG. 6, a flowchart showing manufacturing processes for an illuminant module according to the invention. In FIG. 6, first of all, an illuminant with a slender tube, a cold cathode fluorescent lamp for example, is provided in step 502. Next, proceed to step 504 where a transparent protective layer is formed outside the illuminant with the transparent protective layer enveloping at least a part of the tube of the illuminant. For example, the transparent protective layer is formed outside the illuminant via an ejection method according to the invention. After that, proceed to step 506 where a reflecting plated layer is formed inside the transparent protective layer with the reflecting plated layer being situated at one side of the tube of the illuminant. For example, a reflecting plated layer is formed outside a part of the tube of the illuminant via an electroplating method. The manufacturing method ends here. Therefore, the abovementioned illuminant modules 100, 200, 300 and 400 can be obtained by means of the manufacturing method disclosed in FIG. 6.

Anyone who is familiar with the invention can understand that the technology of the invention is not limited thereto. For example, according to the invention, the illumination efficiency of the illuminant can be improved by installing the reflecting plated layer to be outside a part of the tube of the illuminant and the lower surface of the transparent protective layer under the premise of the design that the reflecting plated layer be able to effectively reflect the light generated by the illuminant. Of which, the transparent protective layer can be made of transparent plastic or glasses with high transmissivity; the transparent protective layer is metallic. Besides, at the two ends of the illuminant module there are exposed circuits passing through the transparent protective layer allowing the illuminant to be electrically connected with outer elements such that illumination can be provided.

Moreover, the illuminant module according to the invention allows the shape of the cross-section area of the transparent protective layer to be adapted and changed according to different shapes of the cross-section area of different illuminant so that the structure of the illuminant can be protected with its compressive strength and seismic resistance being enhanced.

It is noteworthy that the illuminant module according to the invention can be installed in the chassis of a scanner providing needful scanned light so that the chassis is able to scan a document. As for the process regarding how a chassis scans a document is not meant to be repeated here. Of which, the illuminant module can be buckled into the lamp holder of the chassis, or even can be directly buckled into the chassis in the absence of a lamp holder.

The illuminant module and its manufacturing methods disclosed in the foregoing preferred embodiments according to the invention have the following advantages, including:

1. the design of a transparent protective layer protects the structure of the illuminant and enhances the compressive strength and seismic resistance of the illuminant, preventing the illuminant from being damaged by collision or compression caused by external forces;

2. the design of a reflecting plated layer reflects the light generated by the illuminant and directs the light to be emitted outwardly in the same direction via one side of the illuminant module, improving illumination efficiency and illuminant accuracy; and

3. the illuminant module according to the invention can be directly buckled into the chassis, simplifying assembly procedures and saving the user assembly time as well.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An illuminant module used to be installed in an image retrieving device, comprising:
an illuminant;
a transparent protective layer which envelops at least a part of the tube of the illuminant and is used to protect the structure of the illuminant; and
a reflecting plated layer, which, being installed in the transparent protective layer but situated at one side of the tube of the illuminant, is used to reflect a part of the light generated by the illuminant and direct the light to be emitted outwardly in the same direction.

2. The illuminant module according to claim 1, wherein the illuminant is a cold cathode fluorescent lamp (CCFL).

3. The illuminant module according to claim 1, wherein the transparent protective layer envelops the entire tube of the illuminant.

4. The illuminant module according to claim 3, wherein the transparent protective layer further comprises:
a light concentrating area, which, being situated at another side of the tube of the illuminant and being opposite to the reflecting plated layer, is used to concentrate the light generated by the illuminant.

5. The illuminant module according to claim 1, wherein the reflecting plated layer is formed inside the transparent protective layer via an electroplating method.

6. The illuminant module according to claim 1, wherein the transparent protective layer is formed outside the illuminant via and ejection method.

7. The illuminant module according to claim 1, wherein the transparent protective layer is made of transparent plastic.

8. The illuminant module according to claim 1, wherein the transparent protective layer is a transparent glass.

9. The illuminant module according to claim 1, wherein the transparent protective layer is a metal.

10. The illuminant module according to claim 1, wherein the reflecting plated layer covers a part of the tube of the illuminant.

11. The illuminant module according to claim 1, wherein the image retrieving device is a scanner.

12. A manufacturing method for illuminant module, comprising:
providing an illuminant;
forming a transparent protective layer outside the illuminant with the transparent protective layer enveloping at lease a part of the tube of the illuminant; and
forming a reflecting plated layer inside the transparent protective layer with the reflecting plated layer being situated at one side of the tube of the illuminant.

13. A manufacturing method according to claim 12, wherein the illuminant is a cold cathode fluorescent lamp.

14. A manufacturing method according to claim 12, wherein the transparent protective layer envelops the entire tube of the illuminant.

15. A manufacturing method according to claim 14, wherein transparent protective layer further comprise:
a light concentrating area, which, being situated at another side of the tube of the illuminant and being opposite to the reflecting plated layer, is used to concentrate the light generated by the illuminant.

16. A manufacturing method according to claim 12, wherein the reflecting plated layer is formed inside the transparent protective layer via an electroplating method.

17. A manufacturing method according to claim 12, wherein the transparent protective layer is formed outside the illuminant via an ejection method.

18. A manufacturing method according to claim 12, wherein the transparent protective layer is made of transparent plastic.

19. A manufacturing method according to claim 12, wherein the transparent protective layer is a transparent glass.

20. A manufacturing method according to claim 12, wherein the transparent protective layer is a metal.

21. An illuminant module used to be installed in a scanner, wherein the illuminant module further comprises:
a cold cathode fluorescent lamp;
a transparent protective layer, which, being formed outside the cold cathode fluorescent lamp via an ejection method, envelops at least a part of the tube of the cold cathode fluorescent lamp and protects the structure of the cold cathode fluorescent lamp; and
a reflecting plated layer, which, being formed inside the transparent protective layer via an electroplating method, is situated at one side of the tube of the cold cathode fluorescent lamp and is used to reflect a part of the light generated by the cold cathode fluorescent lamp and direct the light to be emitted outwardly in the same direction.

22. A manufacturing method for illuminant module, comprising:
providing a cold cathode fluorescent lamp;
forming a transparent protective layer outside the cold cathode fluorescent lamp via an ejection method with the transparent protective layer enveloping at lease a part of the tube of the cold cathode fluorescent lamp; and
forming a plated reflecting layer inside the transparent protective layer via an electroplating method with the reflecting plated layer being situated at one side of the tube of the cold cathode fluorescent lamp.
